(19) United States
(12) Patent Application Publication
(10) Pub. No.: US 2011/0053039 A1
(43) Pub. Date: Mar. 3, 2011

(54) ELECTRODE CATALYST, AND MEMBRANE ELECTRODE ASSEMBLY AND FUEL CELL INCLUDING THE ELECTRODE CATALYST

(75) Inventors: Chan-ho Pak, Seoul (KR); Dong Jin Ham, Anyang-si (KR); Jae-sung Lee, Pohang-si (KR); Hyuk Chang, Seongnam-si (KR); Gang-hong Bae, Jinhae-si (KR)

(73) Assignees: Samsung Electronics Co., Ltd., Suwon-si (KR); Postech Academy-Industry Foundation, Pohang-si (KR)

(21) Appl. No.: 12/634,142

(22) Filed: Dec. 9, 2009

(30) Foreign Application Priority Data
Sep. 1, 2009 (KR) 10-2009-0081975

(51) Int. Cl. H01M 8/10; B01J 27/22; H01M 4/88

(52) U.S. Cl. 429/483; 502/177; 502/101; 429/525

(57) ABSTRACT

An electrode catalyst for a fuel cell having comparable electrochemical activity as a platinum electrode catalyst but is much cheaper than the platinum electrode catalyst has a structure in which palladium and at least one metal catalyst selected from the group consisting of nickel, gold, iron, and silver, and combinations thereof, are supported on a tungsten carbide and carbon mesoporous composite support. A membrane electrode assembly and a fuel cell including the electrode catalyst also has comparable electrochemical activity as a platinum electrode catalyst but is also much cheaper than the platinum electrode catalyst.

### CROSS-REFERENCE TO RELATED APPLICATION

This application claims the benefit of Korean Patent Application No. 10-2009-0081975, filed Sep. 1, 2009, in the Korean Intellectual Property Office, the disclosure of which is incorporated herein by reference.

### BACKGROUND

1. Field of the Invention

The following description relates to electrode catalysts for a fuel cell, and membrane electrode assemblies and fuel cells including the electrode catalyst.

2. Description of the Related Art

A fuel cell contains an electrolyte disposed between two electrodes, which are generally formed of porous metal or carbon. Such a fuel cell is also referred to as a unit cell. A hydrogen gas or another fuel is supplied to an anode from outside the fuel cell, reaches near a reaction region through pores of the electrode, and turns into active hydrogen atoms by being absorbed in a catalyst in the electrode. The active hydrogen atoms turn into protons, and electrons are transmitted to the electrode. The electrons are transferred to a cathode, which is on the opposite side of the anode, through an external circuit. Accordingly, a current is generated by the fuel cell. Water is generated at the cathode as oxygen supplied from outside the fuel cell, the protons transported through the electrolyte, and the electrons transported through the external circuit react together.

An anode in a polymer electrolyte membrane fuel cell (PEMFC) may include a platinum catalyst to accelerate a reaction that generates protons by oxidizing a hydrogen gas. For example, a supported catalyst may include platinum and molybdenum carbide or tungsten carbide covering a part or the whole area of the surface of a carrier. However, platinum is expensive and in limited supply, and thus, the use of platinum hinders wide commercialization of such fuel cells. In order to reduce the amount of a platinum catalyst used, carbonaceous materials that have a large specific surface area and are conductive may be used as a support, and a specific surface area of a platinum catalyst is increased by uniformly depositing minute platinum particles on the support. However, the weight of a platinum catalyst component is generally 40 to 80 wt % based on the entire weight of a supported catalyst, and thus, such fuel cells are expensive.

### SUMMARY

Aspects of the invention provide electrode catalysts for a fuel cell that have excellent hydrogen oxidizing capacity and are cheaper than a platinum catalyst.

Aspects of the invention provide electrodes including the electrode catalyst.

Aspects of the invention provide fuel cells including the electrode catalyst.

Aspects of the invention provide methods of preparing the electrode catalyst for a fuel cell.

Additional aspects will be set forth in part in the description which follows and, in part, will be apparent from the description, or may be learned by practice of the presented embodiments.

Aspects of the invention provide an electrode catalyst for a fuel cell, the electrode catalyst including: a tungsten carbide and carbon composite support; and a catalyst component supported on the tungsten carbide and carbon composite support, wherein the catalyst component includes: palladium; and at least one metal catalyst selected from the group consisting of nickel, gold, iron, and silver, and combinations thereof.

Aspects of the invention provide a membrane electrode assembly (MEA) for a fuel cell, the MEA including: a cathode and an anode disposed to face each other; and an electrolyte membrane disposed between the cathode and the anode, wherein the anode includes: a tungsten carbide and carbon composite support; and a catalyst component supported on the tungsten carbide and carbon composite support, wherein the catalyst component includes: palladium; and at least one metal catalyst selected from the group consisting of nickel, gold, iron, and silver, and combinations thereof.

According to an aspect of the invention, a fuel cell includes: a membrane electrode assembly; and a separating plate disposed on each side of the membrane electrode assembly, wherein the membrane electrode assembly includes: a cathode and an anode disposed to face each other; and an electrolyte membrane disposed between the cathode and the anode, wherein the anode includes: a tungsten carbide and carbon composite support; and a catalyst component supported on the tungsten carbide and carbon composite support, wherein the catalyst component includes: palladium; and at least one metal catalyst selected from the group consisting of nickel, gold, iron, and silver, and combinations thereof.

According to an aspect of the invention, the tungsten carbide and carbon composite support may have a structure in which tungsten carbide crystalline particles form an island phase and carbon forms a sea phase around the tungsten carbide crystalline particles.

According to an aspect of the invention, the tungsten carbide and carbon composite support may be mesoporous particles having an average particle size from about 0.01 to about 100 μm.

According to an aspect of the invention, the tungsten carbide and carbon composite support may include a plurality of pores having a diameter in a range of about 2 to about 5 nm and a pore volume in a range of about 0.08 to about 0.25 cm³/g.

According to an aspect of the invention, the amount of the tungsten carbide and carbon composite support may be from about 60 to about 95 wt % based on the total amount of the electrode catalyst, and the amount of the catalyst component may be from about 5 to about 40 wt % based on the total amount of the electrode catalyst.

According to an aspect of the invention, a weight ratio of palladium to nickel may be from about 99.9:0.1 to about 99.999:0.001 when the at least one metal catalyst is nickel, and a weight ratio of palladium to the at least one metal catalyst may be from about 40:60 to about 70:30 when the at least one metal catalyst is gold, iron, and/or silver.

According to an aspect of the invention, the fuel cell may be a polymer electrolyte membrane fuel cell (PEMFC).

According to an aspect of the invention, a method of preparing an electrode catalyst for a fuel cell, the method includes: dispersing a tungsten and carbon (WC/C) composite support in a first mixed solvent containing polyol and at least one polar solvent selected from the group consisting of water, C1-C4 aliphatic alcohol, and C1-C4 aliphatic ketone to form a WC/C mesoporous composite support dispersion; dissolving a metal catalyst precursor in a water single solvent or a second mixed solvent containing water and at least one polar solvent selected from the group consisting of C1-C4 aliphatic alcohol, C1-C4 aliphatic ketone, and polyol, to form a metal catalyst precursor solution, the metal catalyst precursor comprising a palladium precursor and at least one metal catalyst precursor selected from the group consisting of a nickel precursor, a gold precursor, an iron precursor, and a silver precursor, and combinations thereof; mixing the WC/C mesoporous composite support dispersion and the metal catalyst precursor solution to form a mixture; refluxing the mixture at a pressure from about 1 to about 5 atm and at a temperature from about 120 to about 180° C. to support the metal catalyst on the WC/C composite support; and separating and drying the resultant refluxed mixture to obtain the electrode catalyst.

According to aspects of the invention, the used amount of the first mixed solvent may be from about 50 to about 200 parts by weight based on 100 parts by weight of the WC/C composite support, and a mixing ratio of the polyol to the at least one polar solvent in the first mixed solvent may be about 60 to about 100 parts by weight of the at least one polar solvent based on 100 parts by weight of the polyol.

According to an aspect of the invention, the used amount of the metal catalyst component precursor may be about 3 to about 15 parts by weight based on 100 parts by weight of the water single solvent or the second mixed solvent, and a mixing ratio of the water and the at least one polar solvent in the second mixed solvent may be about 10 to about 30 parts by weight of the at least one polar solvent based on 100 parts by weight of the water.

According to an aspect of the invention, the used amounts of the palladium precursor and the at least one metal catalyst precursor may be adjusted such that a resultant atomic ratio in the electrode catalyst of the palladium to the at least one metal catalyst is from about 3:3 to about 3:1.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cyclic voltammogram showing the performance of catalysts prepared in Examples 3 and 4 and Comparative Examples 6 and 7;

FIG. 2 is a cyclic voltammogram showing the performance of catalysts prepared in Comparative Examples 3 through 5 and 7;

FIG. 3 is a cyclic voltammogram showing the performance of catalysts prepared in Examples 3 and 4 and Comparative Examples 1 and 2;

FIG. 4 is a cyclic voltammogram showing the performance of catalysts prepared in Examples 1 through 3;

FIG. 5 is a graph of a current-voltage (I-V) characteristic and a graph of a current-power (I-P) characteristic converted therefrom, showing the performance of catalysts prepared in Examples 3 and 4 and Comparative Examples 3, 6, and 7;

FIG. 6 is a graph of a I-V characteristic and a graph of a I-P characteristic converted therefrom, showing the performance of catalysts prepared in Examples 3 and 4 and Comparative Examples 1 and 2; and

FIG. 7 is a graph of a I-V characteristic and a graph of a I-P characteristic converted therefrom, showing the performance of catalysts prepared in Examples 1 through 3.

### DETAILED DESCRIPTION

Reference will now be made in detail to the embodiments of the invention, examples of which are illustrated in the accompanying drawings, wherein like reference numerals refer to the like elements throughout. Embodiments are described below in order to explain the invention by referring to the figures.

An electrode catalyst for a fuel cell according to an embodiment of the invention has a structure in which a catalyst component including a combination of palladium and at least one metal catalyst selected from the group consisting of nickel, gold, iron, and silver, and combinations thereof, is supported on a tungsten carbide and carbon mesoporous composite support. Hereinafter, the tungsten carbide and carbon mesoporous composite support will be referred to as a WC/C composite support.

The size of the WC/C composite support is not specifically limited, and may have an average particle size from about 0.01 to about 100 μm, and in detail, from about 0.05 to about 50 μm. When the average particle size is below 0.01 μm, particles may aggregate, and when the average particle size exceeds 100 μm, a specific surface area decreases, thereby decreasing the catalytic activity of the electrode catalyst. The WC/C composite support is a composite of tungsten carbide crystalline particles and carbon, in which the tungsten carbide crystalline particles form an island phase and the carbon forms a sea phase around the tungsten carbide crystalline particles. The WC/C composite support has mesoporous pores. Generally, mesoporous particles may have a pore diameter in a range of about 2 to about 50 nm, but in an embodiment of the invention, the mesoporous pores of the WC/C composite support may have a pore diameter in a range of about 2 to about 5 nm. A pore volume of the WC/C composite support may be in a range of about 0.08 to about 0.25 cm³/g. Such mesoporous particles may operate as a support that supports a metal catalyst component on a surface of the WC/C composite support.

In the electrode catalyst, the amount of the WC/C composite support may be from about 60 to about 95 wt %, or from about 70 to about 90 wt %, based on the total weight of the electrode catalyst. The amount of the catalyst component may be from about 5 to about 40 wt %, or from about 10 to about 30 wt %, or from about 15 to about 20 wt %, based on the total weight of the electrode catalyst. The catalyst component also includes, in addition to palladium, at least one metal catalyst component selected from the group consisting of nickel, gold, iron, and silver, and combinations thereof. In the catalyst component, the weight ratio of palladium to nickel may be from about 99.9:0.1 to about 99.999:0.001, and the weight ratio of palladium to the at least one metal catalyst selected from the group consisting of gold, iron, and silver may be from about 40:60 to about 70:30. When palladium and nickel are supported on the WC/C composite support as the catalyst component, the actual supported amount of nickel is small compared to the supported amount of palladium as described above, and when palladium and the at least one metal catalyst selected from the group consisting of gold, iron, and silver are supported on the WC/C composite support as the catalyst component, the actual supported amount of gold, iron, and silver may be adjusted as desired, as shown above. In any case, when a transmission electron microscopic (TEM) image of the electrode catalyst is observed, it can be seen that palladium-nickel, palladium-gold, or the like, is uniformly distributed on the surface of the WC/C composite support.

The electrode catalyst, in which the catalyst component, such as palladium-nickel, palladium-gold, or the like, is supported on the WC/C composite support, has similar electrochemical activity to an expensive platinum electrode catalyst. The electrode catalyst according to aspects of the invention, for example, shows high activity as an anode catalyst of a polymer electrolyte membrane fuel cell (PEMFC). When only palladium or the WC/C composite support is independently used, hydrogen oxidation activity is low, but when the combination of palladium and the at least one metal catalyst component selected from the group consisting of nickel, gold, iron, and silver, and combinations thereof, is supported on the WC/C composite support, the hydrogen oxidation activity may remarkably increase. Such a strong electrochemical effect has been discovered by the inventors of the application, and will be described in detail with respect to following examples. Accordingly, when the electrode catalyst including a combination of palladium and the at least one metal catalyst component is supported on the WC/C composite support, a fuel cell may be economically prepared.

A membrane electrode assembly (MEA) for a fuel cell, according to an embodiment of the invention, includes a cathode, an anode, and an electrolyte membrane disposed between the cathode and the anode. The anode includes the electrode catalyst according to the aspects of the invention.

A fuel cell according to an embodiment of the invention includes an MEA and a separating plate deposited on both sides of the MEA. The MEA includes a cathode, an anode, and an electrolyte membrane disposed between the cathode and the anode, in which the anode includes the electrode catalyst according to the above embodiment of the invention. The fuel cell may be a PEMFC.

A method of preparing an electrode catalyst for a fuel cell, according to an embodiment of the invention will now be described. First, a method of preparing a WC/C composite support will be described. The WC/C composite support may be prepared by (a) mixing a solution with a surfactant solution to prepare a mixture, in which the solution is obtained by dissolving a polymerizable monomer and a tungsten precursor in a solvent, (b) preparing a tungsten-polymer composite by hydrothermally synthesizing the mixture, in which in the tungsten-polymer composite, the tungsten precursor, and a polymer generated by polymerizing the polymerizable monomer are combined with each other, and (c) separating and calcining the tungsten-polymer composite.

The above method will now be described in detail, according to each operation.

(a) Mixing of Solution with Surfactant Solution to Prepare Mixture.

Here, the polymerizable monomer is not specifically limited as long as it is polymerized within a proper temperature range. Examples of the polymerizable monomer include resorcinol/formaldehyde, phenol/formaldehyde, pyrrole, thiophene, and vinyl chloride, but are not limited thereto. The monomer may be polymerized into a polymer through radical polymerization mechanism, ionic polymerization mechanism, or the like. When resorcinol and formaldehyde are used as the monomers, the resorcinol and the formaldehyde form a copolymer through a dehydration condensation reaction.

Also, a type of the tungsten precursor is not limited as long as the tungsten precursor is a compound that includes a tungsten atom and is able to provide the tungsten atom via calcination. The tungsten precursor may be a tungstate because the tungstate can provide a tungsten atom even when calcination conditions are not excessively severe. Examples of the tungstate include ammonium metatungstate (AMT), ammonium tungstate, sodium tungstate, tungsten chloride, and mixtures thereof, but are not limited thereto.

The solvent may be a polar solvent, and for example, may be water or an alcohol-based solvent. Examples of the alcohol-based solvent include methanol; ethanol; or propanol, such as iso-propanol; butanol; or pentanol. The water may be deionized water.

A molar ratio of the tungsten precursor to the monomer may be from about 1:5 to about 1:200. When the amount of monomer is less than the above molar ratio, the amount of amorphous carbon increases, and when the amount of monomer is greater than the above molar ratio, tungsten carbide having insufficient carbon may be generated.

A molar ratio of the tungsten precursor to the solvent may be from about 1:500 to about 1:3000. When the amount of solvent is less than the above molar ratio, the tungsten precursor and the monomer (reactants) may not be sufficiently mixed, and when the amount of solvent is greater than the above molar ratio, the concentration of the reactants may be too low appropriately react.

A type of the surfactant is not limited as long as it forms pores. The surfactant increases dispersibility of the tungsten precursor, and surrounds the tungsten-polymer composite including the tungsten precursor and the polymer formed from the monomer so that the particle size of the tungsten-polymer composite decreases. Such small particles aggregate with each other due to high surface energy. Here, an internal space of the tungsten-polymer composite increases due to the surfactant, and thus pores are formed in the tungsten-polymer composite as the surfactant is removed during calcination.

Examples of the surfactant include a cationic surfactant, such as CH₃(CH₂)ₙ₋₁N(CH₃)₃Br (here, n=10, 12, 14, or 16); an anionic surfactant, such as CH₃(CH₂)ₙ₋₁COOH (here, n=11, 13, or 15); a neutral surfactant, such as CH₃(CH₂)ₙ₋₁NH₂ (here, n=12 or 16); and a nonionic surfactant, such as CH₃(CH₂)₁₇(PEO)ₙOH (here, n=2 to 20, where PEO stands for polyethylene oxide), but aspects of the invention are not limited thereto. The surfactant solution may be prepared by dissolving the surfactant in a solvent, such as water or alcohol, but is not limited thereto.

A molar ratio of the tungsten precursor to the surfactant may be from about 1:0.5 to about 1:3. When the amount of the surfactant is less than the above molar ratio, it is difficult to form a mesoporous material, and when the amount of the surfactant is greater than the above molar ratio, the WC/C complex includes pores that are too large.

The tungsten precursor, the monomer, the solvent, and the surfactant solution may be mixed all at once, but alternatively, the solid tungsten precursor may be dissolved or dispersed in the solvent first, and then the resulting solution or dispersion may be mixed with the liquid monomer and surfactant solution for uniform mixing.

### (b) Preparing of Tungsten-Polymer Composite by Hydrothermally Synthesizing Mixture

Hydrothermal synthesis precipitates an inorganic oxide having low solubility from a supercritical or subcritical aqueous solution. By using the hydrothermal synthesis, a highly pure single crystal oxide having uniform particle size distribution can be synthesized via a simple one step process.

The mixture is generally hydrothermally synthesized at a temperature in a range from about 100° C. to about 300° C. When the temperature is below 100° C., a reaction may not occur since the temperature is lower than the boiling point of water. When the temperature is above 300° C., the particle size of the tungsten-polymer composite may be too large. A reaction time of the hydrothermal synthesis may be in a range from about 10 to about 48 hours. When the reaction time is below 10 hours, the tungsten-polymer composite may not be sufficiently obtained, and when the reaction time is above 48 hours, the particle size of the tungsten-polymer composite may be large and a pore structure may break.

While hydrothermally synthesizing the mixture, the monomer is polymerized. To facilitate the polymerization reaction of the monomer, a polymerization initiator may be additionally added while hydrothermally synthesizing the mixture. Examples of the polymerization initiator include sodium persulfate, potassium persulfate, and iron chloride, but are not limited thereto.

Here, the polymer generated by polymerizing the monomer forms a gel phase in the solvent, and sinks as a precipitate due to the heavy specific gravity as the tungsten precursor is added to the polymer.

### (c) Separating and Calcining of Tungsten-Polymer Composite

The precipitate is separated through filtering or the like, and then the separated precipitate is calcined under an inert atmosphere so as to form WC/C mesoporous composite support particles.

The precipitate may be separated by using a filtering method using a filter or a centrifugal separating method. Also, nitrogen gas, argon gas, or the like, may be used to form the insert atmosphere. The calcination may be performed in a heating device having a heating space, such as an oven or a heating furnace. A calcination temperature generally is in a range from about 500 to about 1400° C. When the calcination temperature is below 500° C., the WC/C composite may not be formed, and when the calcination temperature is above 1400° C., the surface area of the WC/C composite may be decreased due to a sintering phenomenon.

As the polymer is carbonized, the polymer combines with the tungsten precursor. At this time, portions occupied by the polymer that does not combine with the tungsten precursor and the surfactant form spaces during the calcination, and thus the WC/C mesoporous composite support having pores is obtained.

A method of supporting catalyst components on a surface of the WC/C composite support will now be described.

The WC/C composite support is uniformly dispersed in a first mixed solvent containing polyol and at least one polar solvent selected from the group consisting of water, C1-C4 aliphatic alcohol, and C1-C4 aliphatic ketone, and combinations thereof, so as to prepare a WC/C composite support dispersion. A weight ratio of the WC/C composite support to the first mixed solvent is not specifically limited, and the weight of the first mixed solvent may be from about 50 to about 200 parts by weight based on 100 parts by weight of the WC/C composite support. The polyol is an alcohol compound including at least two —OH groups in a molecule. The polyol stabilizes a catalyst precursor compound, prevents particles of the catalyst precursor compound from aggregating, and reduces the catalyst precursor compound.

A mixture ratio of the polyol to the at least one polar solvent in the first mixed solvent may be about 60 to about 100 parts by weight of the at least one polar solvent based on 100 parts by weight of the polyol. When the used amount of the at least one polar solvent is above 100 parts by weight, large particles may be generated as the particles aggregate during reduction, and the amount of the first mixed solvent may increase, thereby generating a problem, such as difficult adjustment of weights of palladium, nickel, etc. When the used amount of the at least one polar solvent is below 60 parts by weight, large particles may be generated due to a sudden reduction reaction.

Examples of the polyol include ethylene glycol, diethylene glycol, triethylene glycol, propylene glycol, tetraethylene glycol, and polyethylene glycol. Examples of the aliphatic alcohol that may be included in the first mixed solvent include methanol, ethanol, iso-propanol, and butanol. Examples of the aliphatic ketone that may be included in the first mixed solvent include acetone and methyl ethyl ketone.

Aside from the above, a catalyst component precursor solution is prepared by adding and dissolving a metal catalyst component precursor in a water single solvent; or a second mixed solvent containing water and at least one polar solvent selected from the group consisting of C1-C4 aliphatic alcohol, C1-C4 aliphatic ketone, and polyol, and combinations thereof. Examples of the aliphatic alcohol that may be included in the second mixed solvent include methanol, ethanol, iso-propanol, and butanol. Examples of the aliphatic ketone that may be included in the second mixed solvent include acetone and methyl ethyl ketone. A weight ratio of the water single solvent or the second mixed solvent to the metal catalyst component precursor is not specifically limited, but the used amount of the metal catalyst component precursor may be from about 3 to about 15 parts by weight based on 100 parts by weight of the water single solvent or the second mixed solvent. A mixture ratio of the water and the at least one polar solvent in the second mixed solvent may be from about 10 to about 30 parts by weight of the at least one polar solvent based on 100 parts by weight of water.

Palladium may be effectively supported on the WC/C composite support, but the metal catalyst may not be effectively supported on the WC/C composite support compared to the palladium. For example, when the amount of palladium precursor that makes the nominal loading amount of palladium in the total weight of the final catalyst to be 20 wt % is used, the amount of metal catalyst remaining in the final catalyst may be relatively small even when a large amount of precursor of the metal catalyst is used so that an atomic ratio of the palladium to the metal catalyst is from about 3:3 to about 3:1. A relatively large amount of gold, iron, or silver may be supported compared to nickel. Even though the amount of nickel, gold, iron, or silver remaining in the final catalyst may be small compared to the amount of palladium, a catalytic activity is high compared to a case when only palladium is supported, as will be described in detail below. A used amount ratio of the palladium precursor to a precursor of the metal catalyst is adjusted in such a way that an atomic ratio of the palladium to the metal catalyst is from about 3:3 to about 3:1. The atomic ratio of the palladium to the metal catalyst may be 3:1.

Examples of the palladium precursor include palladium (II) chloride, palladium (II) acetylacetonate, palladium (II) cyanide, palladium (II) acetate, palladium (II) sulfide, and palladium (II) nitrate. The examples of the palladium precursor further include PdCl₂, (CH₃COO)₂Pd, PdSO₄, and Pd(NO₃)₂.xH₂O. However, aspects of the invention are not limited thereto.

Examples of the nickel precursor include NiCl₂.6H₂O, (CH₃COO)₂Ni.4H₂O, nickel (II) acetylacetonate, nickel (II) carbonate hydroxide, nickel (II) hydroxide, and Ni(NO₃)₂.6H₂O, NiSO₄.6H₂O, NiI₂, NiF₂. However, aspects of the invention are not limited thereto.

Examples of the gold precursor include HAuCl₄.3H₂O, Au(OH)₃, AuCl₃, and AuCN. However, aspects of the invention are not limited thereto.

Examples of the iron precursor include (CH₃COO)₂Fe, iron (III) acetylacetonate, FeCl₂.4H₂O, FeCl₂, FeCl₃.6H₂O, Fe(NO₃)₂, FeC₂O₂, FeSO₄, FeI₂, and FeF₂. However, aspects of the invention are not limited thereto.

Examples of the silver precursor include CH₃COOAg, silver acetylacetonate, Ag₂CO₃, and AgNO₃. However, aspects of the invention are not limited thereto.

Then, the catalyst component precursor solution is mixed with the WC/C mesoporous composite support dispersion so as to prepare a mixture, and the mixture is hydrothermally synthesized by refluxing the mixture at a pressure from about 1 to about 5 atm and at a temperature from about 120 to about 180° C. for from about 1 to about 3 hours.

Next, the reaction product thereof is filtered, washed, and dried at room temperature, thereby obtaining a catalyst in which the combination of palladium and the at least one metal catalyst is supported on the WC/C composite support.

### EXAMPLES

### Synthesis Example

### Preparation of WC/C Composite Support

27 ml of a cetyl trimethyl ammonium bromide (CTABr) 25% aqueous solution was prepared as a surfactant. A first dispersion was obtained by dispersing 5 g of ammonium metatungstate (manufactured by Aldrich) in 20 ml of water. A mixture of 1.2 g of resorcinol and 1.8 ml of 30% formaldehyde was added to the first dispersion, and was stirred to be uniformly dispersed in the first dispersion, so as to obtain a second dispersion.

The CTABr 25% aqueous solution and the second dispersion were put into a stainless-steel high-pressure reactor having a volume of 250 ml and were hydrothermally processed for 2 days at pressure of 5 atm and at a temperature of 150° C. After the reaction, a tungsten precursor-polymer composite in a gel phase was precipitated on the bottom of the high-pressure reactor.

The tungsten precursor-polymer composite was filtered, washed, and then dried for one day at a temperature of 110° C. so as to obtain about 11 g of dried tungsten precursor-polymer composite.

The dried tungsten precursor-polymer composite was heated for 1 hour at a temperature of 900° C. under an argon gas atmosphere, and then further heated for 2 hours at a temperature of 900° C. under a hydrogen gas atmosphere so as to obtain about 4.5 g of WC/C composite support.

Upon analyzing the WC/C composite support at an acceleration voltage of 200 kV by using a X-ray diffractometer (CM-200 manufactured by Philips), and a transmission electron microscope (JEM 2010F manufactured by JEOL), it was found that, in the WC/C composite support, the WC nano-particles formed an island phase, and the carbon formed a sea phase surrounding the island phase.

Upon analyzing an adsorption isotherm of the WC/C composite support by using ASAP 2010 manufactured by Micromeritics, and pore size distribution of the WC/C composite support, it was found that the WC/C composite support followed an IV-type adsorption isotherm, most pores of the WC/C composite support had a diameter from about 2 to about 5 nm, and the WC/C composite support was formed of mesoporous particles having a pore volume of about 0.24 cm³/g.

A surface area of the WC/C composite support was about 76 m²/g, which was calculated by using a BET absorption equation in a nitrogen gas absorption test, and an average diameter of the WC/C composite support was about 0.02 μm,

### Example 1

A catalyst was prepared by supporting palladium and nickel as catalyst components on the WC/C composite support obtained in the Synthesis Example. A used amount of the palladium precursor was adjusted so that the nominal loading amount of the palladium was to be 20 wt % based on the total weight of the catalyst. Also, a used amount of the nickel precursor was adjusted so that an atomic ratio (used amount) of palladium to nickel was to be 3:3 in the reaction mixture. In table 1, the catalyst prepared in Example 1 is indicated as 20 wt % Pd₃Ni₃/WC/C. In this case, “20 wt %” indicates the nominal loading amount of the palladium based on the total weight of the catalyst. “Pd₃Ni₃” indicates that the palladium precursor and the nickel precursor are used in such a way that the atomic ratio of palladium to nickel in the mixture is to be 3:3. “WC/C” indicates that a carrier is a tungsten carbide and carbon mesoporous composite support. Such an indicating method is identically applied to other catalysts in Table 1.

0.6 g of the WC/C composite support obtained in the Synthesis Example, 101 ml of ethylene glycol, and 34 ml of distilled water were put into a 0.5 L round-bottomed flask purged with nitrogen gas and were stirred so as to be uniformly mixed. Then, a catalyst component precursor aqueous solution obtained by uniformly mixing 64 ml of distilled water, 0.25 g of PdCl₂, and 0.335 g of NiCl₂.6H₂O was added to the round-bottomed flask. The resultant thereof was stirred for 30 minutes at a temperature of 25° C. and at a pressure of 1 atm. Next, the temperature of the round-bottomed flask was increased to 140° C., and then the resultant was refluxed for 2 hours.

After the reflux, the reaction product was filtered, washed, and dried at room temperature so as to obtain about 0.66 g of Pd₃Ni₃/WC/C composite support catalyst. In the Pd₃Ni₃/WC/C composite support catalyst, a weight ratio of palladium to nickel was 99.9:0.1 and the supported amount of palladium was about 18.05 wt % based on the total amount of the Pd₃Ni₃/WC/C composite support catalyst, which were measured by inductivity coupled plasma (ICP) optical emission spectroscopy.

### Example 2

A catalyst was prepared by supporting palladium and nickel as catalyst components on the WC/C composite support obtained in the Synthesis Example. A used amount of the palladium precursor was adjusted so that the nominal loading amount of the palladium was to be 20 wt % based on the total weight of the catalyst. Also, a used amount of the nickel precursor was adjusted so that an atomic ratio (used amount) of palladium to nickel was to be 3:2 in the reaction mixture.

About 0.66 g of Pd₃Ni₂/WC/C composite support catalyst was obtained in the same manner as in Example 1, except that 0.25 g of PdCl₂ and 0.223 g of NiCl₂.6H₂O were used while preparing the catalyst component precursor aqueous solution.

In the Pd₃Ni₂/WC/C composite support catalyst, a weight ratio of palladium to nickel was 99.93:0.07 and the supported amount of palladium was 19.04 wt % based on the total weight of the Pd₃Ni₂/WC/C composite support catalyst, which were measured by ICP optical emission spectroscopy.

### Example 3

A catalyst was prepared by supporting palladium and nickel as catalyst components on the WC/C composite support obtained in the Synthesis Example. A used amount of the palladium precursor was adjusted so that the nominal loading amount of the palladium was to be 20 wt % based on the total weight of the catalyst. Also, a used amount of the nickel precursor was adjusted so that an atomic ratio (used amount) of palladium to nickel was to be 3:1 in the reaction mixture.

About 0.66 g of Pd₃Ni₁PdNi/WC/C composite support catalyst was obtained in the same manner as in Example 1, except that 0.25 g of PdCl₂ and 0.112 g of NiCl₂.6H₂O were used while preparing a catalyst component precursor aqueous solution.

In the Pd₃Ni₁PdNi/WC/C composite support catalyst, a weight ratio of palladium to nickel was 99.95:0.05 and the supported amount of palladium was 19.12 wt % based on the total weight of the Pd₃Ni₁/WC/C composite support catalyst, which were measured by using an ICP optical emission spectroscopy.

### Example 4

A catalyst was prepared by supporting palladium and gold as catalyst components on the WC/C composite support obtained in the Synthesis Example. A used amount of the palladium precursor was adjusted so that the nominal loading amount of the palladium was to be 20 wt % based on the total weight of the catalyst. Also, a used amount of the gold precursor was adjusted so that an atomic ratio (used amount) of palladium to gold was to be 3:1 in the reaction mixture.

0.6 g of the WC/C composite support obtained in the Synthesis Example, 101 ml of ethylene glycol, and 34 ml of distilled water were put into a 0.5 L round-bottomed flask purged with nitrogen gas and were stirred so as to be uniformly mixed. Then, a catalyst component precursor aqueous solution obtained by uniformly mixing 64 ml of distilled water, 0.25 g of PdCl₂, and 0.16 g of HAuCl₄.3H₂O was added to the round-bottomed flask. The resultant thereof was stirred for 30 minutes at a temperature of 25° C. and at a pressure of 1 atm. Next, the temperature of the round-bottomed flask was increased to 140° C., and then the resultant was refluxed for 2 hours.

After the reflux, the reaction product was filtered, washed, and dried at room temperature so as to obtain about 0.66 g of Pd₃Au₁/WC/C composite support catalyst. In the Pd₃Au₁/WC/C composite support catalyst, a weight ratio of palladium to gold was 66.4:33.6 and the supported amount of palladium was about 18.34 wt % based on the total amount of the Pd₃Au₁/WC/C composite support catalyst, which were measured by ICP optical emission spectroscopy.

### Comparative Example 1

A catalyst was prepared by supporting palladium and nickel as catalyst components on a carbon carrier. A used amount of the palladium precursor was adjusted so that the nominal loading amount of the palladium was to be 20 wt % based on the total weight of the catalyst. Also, a used amount of the nickel precursor was adjusted so that an atomic ratio (used amount) of palladium to nickel was to be 3:1 in the reaction mixture.

0.6 g of carbon black (Vulcan XC-72 manufactured by Cabot Corporation) carrier, 101 ml of ethylene glycol, and 34 ml of distilled water were put into a 0.5 L round-bottomed flask purged with nitrogen gas and were stirred so as to be uniformly mixed. Then, a catalyst component precursor aqueous solution obtained by uniformly mixing 64 ml of distilled water, 0.25 g of PdCl₂, and 0.112 g of NiCl₂.6H₂O was added to the round-bottomed flask. The resultant thereof was stirred for 30 minutes at a temperature of 25° C. and at an atmospheric pressure of 1 atm. Next, the temperature of the round-bottomed flask was increased to 140° C., and then the resultant was refluxed for 2 hours.

After the reflux, the reaction product was filtered, washed, and dried at room temperature so as to obtain about 0.64 g of Pd₃Ni₁/C catalyst. In the Pd₃Ni₁/C catalyst, a weight ratio of palladium to nickel was 99.9:0.1 and the supported amount of palladium was about 17.66 wt % based on the total amount of the Pd₃Ni₁/C catalyst, which were measured by ICP optical emission spectroscopy.

### Comparative Example 2

A catalyst was prepared by supporting palladium and gold as catalyst components on a carbon carrier. A used amount of the palladium precursor was adjusted so that the nominal loading amount of the palladium was to be 20 wt % based on the total weight of the catalyst. Also, a used amount of the gold precursor was adjusted so that an atomic ratio (used amount) of palladium to gold was 3:1 in the reaction mixture.

About 0.64 g of Pd₃Au₁/C catalyst was obtained in the same manner as in Comparative Example 1, except that 0.16 g of HAuCl₄.3H₂O was used instead of NiCl₂.6H₂O while preparing the catalyst component precursor aqueous solution.

A weight ratio of palladium to gold was 66.2:33.8 and the supported amount of palladium was 16.28 wt % based on the total weight of Pd₃Au₁/C catalyst, which were measured by ICP optical emission spectroscopy.

### Comparative Example 3

A catalyst was prepared by supporting only palladium as a catalyst component on a carbon carrier. A used amount of the palladium precursor was adjusted so that the nominal loading amount of the palladium was to be 20 wt % based on the total weight of the catalyst.

About 0.64 g of Pd/C catalyst was obtained in the same manner as in Comparative Example 1, except that 0.25 g of PdCl₂ was used without NiCl₂.6H₂O while preparing the catalyst component precursor aqueous solution.

The supported amount of palladium was 18.13 wt % based on the total weight of Pd/C catalyst, which was measured by ICP optical emission spectroscopy.

### Comparative Example 4

The WC/C composite support obtained in the Synthesis Example was used as an anode catalyst.

### Comparative Example 5

A catalyst was prepared by supporting only platinum as a catalyst component on the WC/C composite support obtained in the Synthesis Example. A used amount of the platinum precursor was adjusted so that the nominal loading amount of the platinum was to be 20 wt % based on the total weight of the catalyst.

About 0.64 g of Pt/WC/C catalyst was obtained in the same manner as in Example 1, except that 0.375 g of H₂PtCl₆.6H₂O was used without NiCl₂.6H₂O while preparing the catalyst component precursor aqueous solution.

The supported amount of platinum was 18.23 wt % based on the total weight of Pt/WC/C catalyst, which was measured by ICP optical emission spectroscopy.

### Comparative Example 6

A Pt/C catalyst (JM1000) commercialized by Johnson & Matthey, in which the nominal loading amount of platinum on a carbon black carrier is 20 wt % based on the total weight of the Pt/C catalyst, was used as an anode catalyst.

### Comparative Example 7

A catalyst was prepared by supporting only palladium as a catalyst component, on the WC/C composite support prepared in the Synthesis Example. A used amount of the palladium precursor was adjusted so that the nominal loading amount of the palladium was to be 20 wt % based on the total weight of the catalyst.

About 0.66 g of Pd/WC/C catalyst was obtained in the same manner as in Example 1, except that 0.25 g of PdCl₂ was used without NiCl₂.6H₂O while preparing the catalyst component precursor aqueous solution.

The supported amount of palladium was 18.57 wt % based on the total weight of Pd/WC/C catalyst, which was measured by ICP optical emission spectroscopy.

Half Cell Test

An electrode was prepared as follows by using the catalysts prepared in Examples 1 through 4 and Comparative Examples 1 through 7.

First, 20 mg of each of the catalysts, 1 ml of distilled water, and 10 μl of NAFION® 10 wt % solution (prepared by Aldrich) were mixed so as to prepare a mixture. Then, the mixture was homogenized for 30 minutes by using ultrasonication so as to obtain a dispersion. A glassy carbon electrode (MF-2012 manufactured by BASi) was coated with 5 μl of the obtained dispersion and then dried, and was again coated with 5 μl of NAFION® solution as a fixture, and then dried.

In order to compare the hydrogen oxidation activity of each of the catalysts prepared according to Examples 1 through 4 and Comparative Examples 1 through 7, a half cell test was performed on the electrodes prepared as above.

Each of the electrodes was used as a working electrode, Ag/AgCl (3M NaCl) was used as a reference electrode, and a platinum line was used as a counter electrode. 1 M sulfuric acid solution was used as an electrolyte, and, in order to remove gas dissolved in the electrolyte, nitrogen was supplied to the electrolyte for 30 minutes before the half cell test. Then, the performance of each electrode was measured at a sweep speed of 50 mV/sec using a potentiostat/galvanostat (EG&G Prinston Applied Research M273) while performing hydrogen oxidation at room temperature on each electrode.

The characteristics of the cyclic voltaammograms of each working electrode were analyzed in a range of about −0.2 V to about 0.9 V (vs. Ag/AgCl). The characteristics were analyzed through a voltage-current curve of the last cycle that reached a steady state, by cycling the each electrode 20 cycles. The results of half cell tests were also compared with activity of a working electrode prepared by using the commercial Pt/C catalyst of Comparative Example 6.

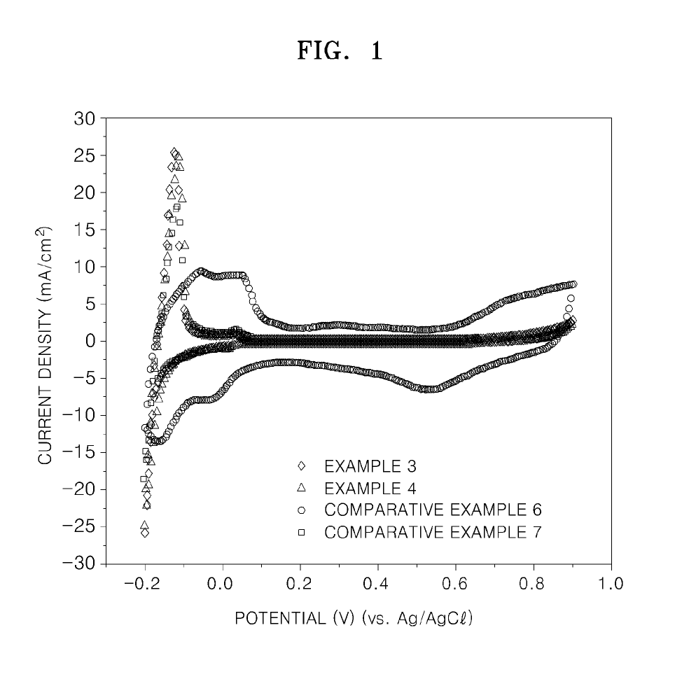

FIGS. 1 through 4 illustrate the results of half cell tests performed on the electrodes prepared by using the catalysts of Examples 1 through 4 and Comparative Examples 1 through 7.

FIG. 1 is a cyclic voltammogram showing performance of the catalysts prepared in Examples 3 and 4 and Comparative Examples 6 and 7. Referring to FIG. 1, the Pd₃Ni₁/WC/C catalyst of Example 3, in which the nominal loading amount 20 wt % of palladium is supported on the WC/C composite support and the used amount of palladium to nickel is 3:1 (atomic ratio), the Pd₃Au₁/WC/C catalyst of Example 4, in which the nominal loading amount 20 wt % of palladium is supported on the WC/C composite support and the used amount of palladium to gold is 3:1 (atomic ratio), and the Pd/WC/C catalyst of Comparative Example 7, in which the nominal loading amount 20 wt % of palladium is supported on the WC/C composite support, have different peak shapes from a peak shape of the commercial Pt/C catalyst of Comparative Example 6. In other words, the commercial Pt/C catalyst of Comparative Example 6 shows hydrogen adsorption and desorption characteristic across a wide voltage region. Although peak areas of the catalysts of Examples 3 and 4 and Comparative Example 7 are smaller that that of the catalyst of Comparative Example 6, the catalysts of Examples 3 and 4 and Comparative Example 7 show large high oxidation current peaks in a low voltage region where hydrogen oxidation activity is high. The catalysts of Examples 3 and 4 and Comparative Example 7 respectively have peaks at −0.124 V, −0.118 V, and −0.119 V. The catalysts of Examples 3 and 4 and Comparative Example 7 show good oxidation current peak area from about 62 to about 80% compared to the catalyst of Comparative Example 6 in a range from about −0.2 V to about 0.2 V (vs. Ag/AgCl). The catalysts of Examples 3 and 4 show better oxidation current peak areas than the catalyst of Comparative Example 7.

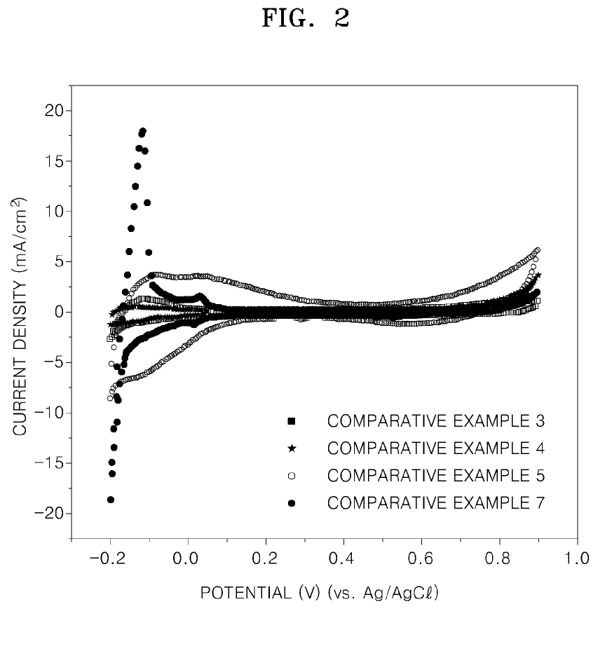

FIG. 2 is a cyclic voltamogram showing the performance of catalysts prepared in Comparative Examples 3 through 5 and 7. An oxidation current peak area of the catalyst of Comparative Example 7, in which the nominal loading amount 20 wt % of palladium is supported on the WC/C composite support, has about 62% of an oxidation current peak area of the commercial Pt/C catalyst of Comparative Example 6 in a range from about −0.2 V to about 0.2 V (vs. Ag/AgCl), i.e., a hydrogen adsorption and desorption area during scanning in an oxidation direction. This shows that when the catalyst of Comparative Example 7 is compared with the commercial Pt/C catalyst of Comparative Example 6, the catalyst of Comparative Example 7 shows about 62% of hydrogen oxidation activity of the commercial Pt/C catalyst of Comparative Example 6 according to the hydrogen absorption and desorption area.

Also, the catalyst of Comparative Example 7 shows a larger activity, i.e., a higher hydrogen oxidation current, than the catalyst of Comparative Example 3, in which the nominal loading amount 20 wt % of palladium is supported on the carbon support, and the catalyst of Comparative Example 4, in which the pure WC/C composite support that is not supported by any metal component is used. In other words, the catalyst of Comparative Example 3 shows a very small oxidation current peak in the same range compared to the catalyst of Comparative Example 7. The oxidation current peak area of Comparative Example 3 is about 11% of the oxidation current peak area of the commercial Pt/C catalyst of Comparative Example 6. The catalyst of Comparative Example 4 shows a smaller oxidation current peak than the catalyst of Comparative Example 7. The oxidation current peak area of Comparative Example 4 is only about 4% of the oxidation current peak area of the commercial Pt/C catalyst of Comparative Example 6.

An oxidation current peak area of the catalyst of Comparative Example 5, in which the nominal loading amount 20 wt % of platinum is supported on the WC/C composite support, has about 61% of an oxidization oxidation current peak area of the commercial Pt/C catalyst of Comparative Example 6 in a range from about −0.2 V to about 0.2 V (vs. Ag/AgCl). The catalyst of Comparative Example 5 has a similar oxidation current peak area to that of the catalyst of Comparative Example 7 but has a different peak shape from that of the catalyst of Comparative Example 7.

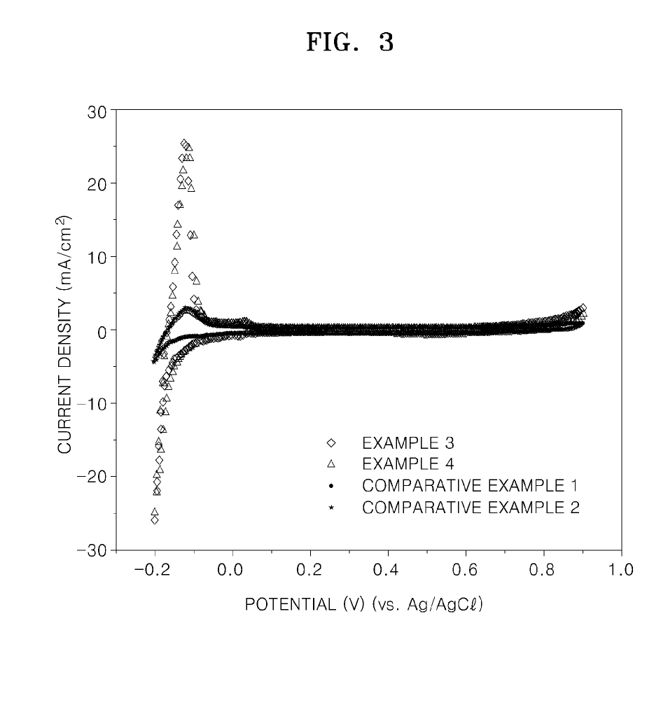

FIG. 3 is a cyclic voltammogram showing performance of catalysts prepared in Examples 3 and 4 and Comparative Examples 1 and 2 when palladium (Pd) and nickel (Ni) or Pd and gold (Au) are used as catalyst components. The plot lines of the catalysts of Comparative Examples 1 and 2 overlap each other and, thus, are not distinguished from each other. Referring to FIG. 3, Examples 3 (Pd and Ni) and 4 (Pd and Au), in which supports are the WC/C composite support, show remarkably higher hydrogen oxidation currents than Comparative Examples 1 (Pd and Ni) and 2 (Pd and Au), in which supports are carbon.

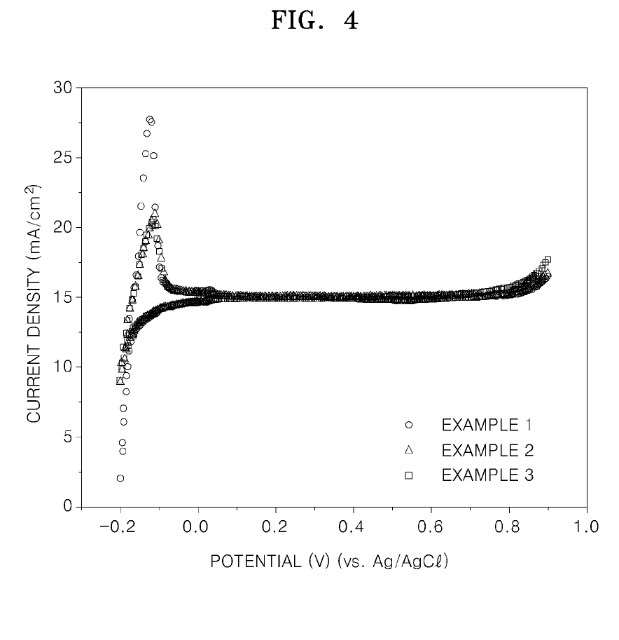

FIG. 4 is a cyclic voltammogram showing the performance of catalysts prepared in Examples 1 through 3, in which the WC/C composite support is used as a carrier and Pd and Ni are used as catalyst components, but the amounts of Ni used differ in Examples 1 through 3. Referring to FIG. 4, the catalyst of Example 3, in which the used amount of palladium to nickel is 3:1 (atomic ratio), shows the highest hydrogen oxidation current (hydrogen adsorbing and desorbing capability) compared to the catalysts of Examples 1 and 2, in which the used amounts of palladium to nickel are respectively 3:3 and 3:2 (atomic ratio).

Unit Cell Test

An anode was prepared as follows by using the catalysts of Examples 1 through 4 and Comparative Examples 1 through 7. A slurry for forming an anode catalyst layer was prepared by uniformly mixing 1.2 ml of iso-propyl alcohol, 0.4 g of NAFION® solution, and an amount of each of the catalysts according to Examples 1 through 4 and Comparative Examples 1 through 3 and 5 through 7, so that the amount of catalysts in the anode was to be 0.3 mg_{Pd}/cm² (Examples 1 through 4 and Comparative Examples 1 through 3 and 7) or 0.3 mg_{Pt}/cm² (Comparative Examples 5 and 6). A carbon paper (TGPH-060 manufactured by Toray) was spray-coated with the slurry, dried for a night in air, and then dried for 2 hours in a vacuum oven at a temperature of 80° C. so as to prepare an anode.

A cathode was prepared in the same manner as the anode by using the commercial Pt/C catalyst of Comparative Example 6 so that the amount of catalyst in the cathode was to be 0.3 mg_{Pt}/cm². In other words, a slurry for forming a cathode catalyst layer was prepared by uniformly mixing 1.2 ml of iso-propanol, 0.4 g of NAFION® solution, and 0.047 g of the commercial 20 wt % Pt/C catalyst. A carbon paper (TGPH-060 manufactured by Toray) was spray-coated with the slurry, dried for a night in air, and then dried for 2 hours in a vacuum oven at a temperature of 80° C. so as to prepare an cathode.

The anode and the cathode were stacked on each side of a proton conductive polymer membrane (NAFION® 212 membrane, manufactured by DuPont), and then the resulting structure was hot-pressed for 2 minutes at a temperature of 125° C. and at a pressure of 1500 psia so as to prepare a membrane electrode assembly (MEA). A separating plate for supplying fuel and a separating plate for supplying oxidizing and reducing agent were respectively attached to the anode and the cathode so as to prepare a unit cell.

Cell performances of the unit cells prepared by using the catalysts of Examples 1 through 4 and Comparative Examples 1 through 3, 6, and 7 were analyzed as follows. The cell performances of the unit cells were analyzed at a temperature of 60° C. by using a cell tester (Won A Tech, Smart II). Hydrogen gas was supplied to the separating plate for supplying fuel at a flow rate of 150 ml/min, and air was supplied to the separating plate for supplying reducing agent at a flow rate of 1 L/min. The cell performances were analyzed by measuring changes in voltage and power density according to change in current density.

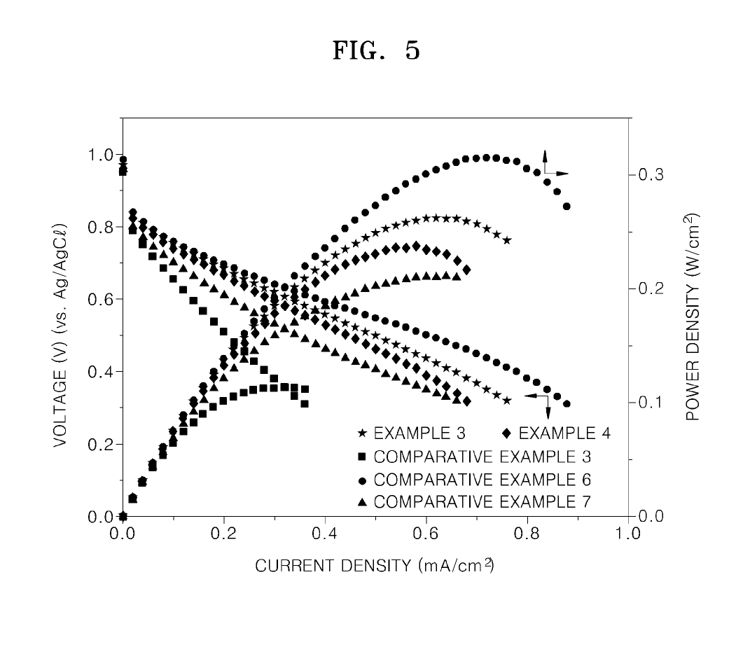

Results of the unit cell tests performed on the electrodes prepared by using the catalysts of Examples 1 through 4 and Comparative Examples 1 through 3, 6, and 7 are shown in FIGS. 5 through 7.

FIG. 5 is a graph of a current-voltage (I-V) characteristic and a graph of a current-power (I-P) characteristic converted therefrom, showing the performance of the catalysts prepared in Examples 3 and 4 and Comparative Examples 3, 6, and 7. Referring to FIG. 5, the Pd₃Ni₁/WC/C catalyst of Example 3 has a maximum power density of about 263 mW/cm², and the Pd₃Au₁/WC/C catalyst of Example 4 has a maximum power density of about 238 mW/cm². Such maximum power densities of Examples 3 and 4 correspond to at least about 209% of the maximum power density of the Pd/C catalyst of Comparative Example 3, i.e., 209% of about 114 mW/cm², and respectively about 75.7% and 83.7% of the maximum power density, of the commercial Pt/C catalyst of Comparative Example 6, i.e. respectively about 75.7% and 83.7% of about 314 mW/cm². Accordingly, it is seen that the hydrogen oxidation activity was remarkably increased when nickel or gold is added to palladium.

The Pd/WC/C catalyst of Comparative Example 7 shows the maximum power density of about 211 mW/cm². The maximum power density of the Pd/WC/C catalyst of Comparative Example 7 is about 67% of that of the commercial Pt/C catalyst of Comparative Example 6, but is much smaller than the catalysts of Examples 3 and 4.

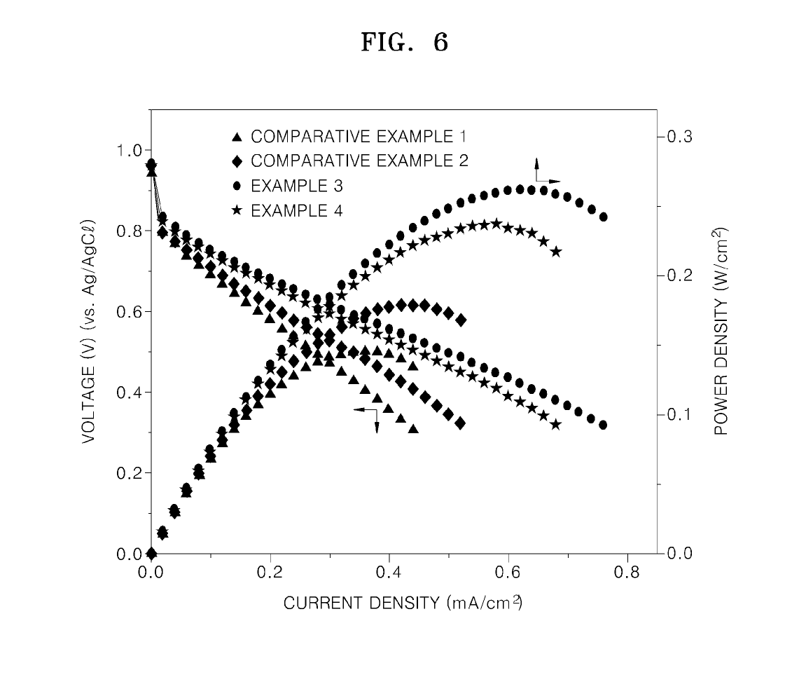

FIG. 6 is a graph of a I-V characteristic and a graph of a I-P characteristic converted therefrom, showing the performance of the catalysts prepared in Examples 3 and 4, and Comparative Examples 1 and 2, in which Pd and Ni, or Pd and Au are used as catalyst components. Referring to FIG. 6, the maximum power density is remarkably higher when a carrier is the WC/C composite support (Examples 3 (Pd and Ni) and 4 (Pd and Au)) than when a carrier is carbon (Comparative Examples 1 (Pd and Ni) and 2 (Pd and Au)). In other words, the maximum power density of the Pd₃Ni₁/WC/C catalyst of Example 3 is about 263 mW/cm² and the maximum power density of the Pd₃Au₁/WC/C catalyst of Example 4 is about 238 mW/cm², whereas the maximum power density of the Pd₃Ni₁/C catalyst of Comparative Example 1 is about 148 mW/cm² and the maximum power density of the Pd₃Au₁/C catalyst of Comparative Example 2 is about 179 mW/cm².

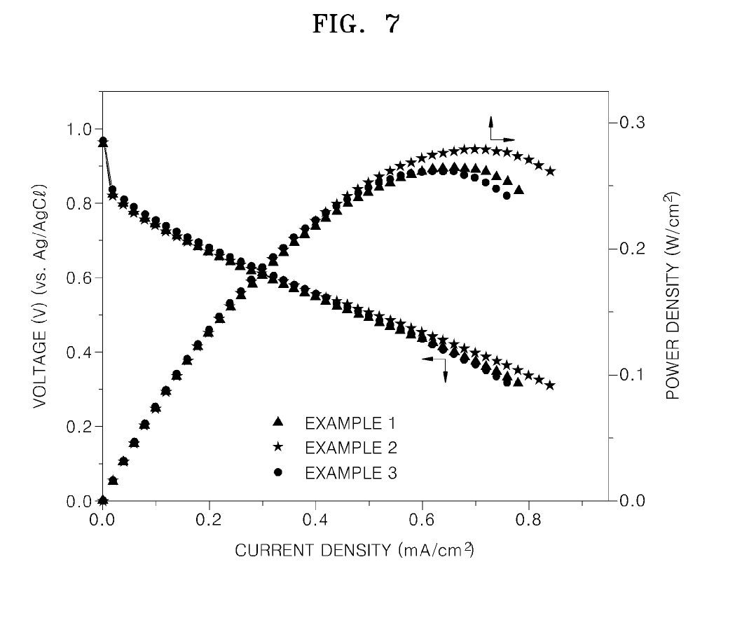

FIG. 7 is a graph of a I-V characteristic and a graph of a I-P characteristic converted therefrom, showing the performance of the catalysts prepared in Examples 1 through 3, in which the WC/C composite support is used as a carrier and Pd and Ni are used as catalyst components, but the amounts of Ni used differ in Examples 1 through 3.

Referring to FIG. 7, the catalysts of Examples 1 through 3 have similar I-V characteristics and I-P characteristics. Specifically, the catalysts of Examples 1 through 3 show at least about 83.7% of the maximum power density of the commercial Pt/C catalyst of Comparative Example 6, as shown in Table 1 below. Accordingly, it is seen that the hydrogen oxidation activity remarkably increases when nickel is added to palladium.

Table 1 shows detailed results of the half cell tests.

TABLE 1

| | | Maximum | Ratio (%) with | Ratio (%) with |
|---|---|---|---|---|
| | | Power | respect to | respect to |
| | | Density | Comparative | Comparative |
| | Anode Catalyst | (mW/cm²) | Example 3 | Example 6 |
| Example 1 | 20 wt % Pd₃Ni₃/WC/C | 265 | 232.4 | 84.3 |
| Example 2 | 20 wt % Pd₃Ni₂/WC/C | 280 | 245.6 | 89.1 |
| Example 3 | 20 wt % Pd₃Ni₁/WC/C | 263 | 230.7 | 83.7 |
| Example 4 | 20 wt % Pd₃Au₁/WC/C | 238 | 208.7 | 75.7 |
| Comparative | 20 wt % Pd₃Ni₁/C | 148 | 129.8 | 47.1 |
| Example 1 | | | | |
| Comparative | 20 wt % Pd₃Au₁/C | 179 | 157.0 | 57.0 |
| Example 2 | | | | |
| Comparative | 20 wt % Pd/C | 114 | 100 | 36.3 |
| Example 3 | | | | |
| Comparative | 20 wt % Pt/WC/C | 224 | 196.4 | 71.3 |
| Example 5 | | | | |
| Comparative | 20 wt % Pt/C (JM1000) | 314 | 275.4 | 100 |
| Example 6 | | | | |
| Comparative | 20 wt % Pd/WC/C | 211 | 185.0 | 67.1 |
| Example 7 | | | | |

As described above, according to the one or more of the above embodiments of the invention, the electrode catalyst for a fuel cell has high hydrogen oxidation activity due to strong synergistic effect between palladium and tungsten carbide and synergistic effect of at least two catalyst components including palladium, by supporting a combination of palladium and at least one metal catalyst selected from the group consisting of nickel, gold, iron, and silver, and combinations thereof, on the WC/C composite support. In detail, the electrode catalyst shows high hydrogen oxidation activity that is comparable to an expensive commercial Pt/C catalyst that is widely used as an anode catalyst. Accordingly, the electrode catalyst can effectively replace a platinum electrode catalyst that is important in a PEMFC, in terms of electrochemical activity and price competitiveness, and thus contribute to commercialization of PEMFCs.

Although a few embodiments of the invention have been shown and described, it would be appreciated by those skilled in the art that changes may be made in these embodiments without departing from the principles and spirit of the invention, the scope of which is defined in the claims and their equivalents.

What is claimed is:

1. An electrode catalyst for a fuel cell, the electrode catalyst comprising:
a tungsten carbide and carbon composite support; and
a catalyst component supported on the tungsten carbide and carbon composite support,
wherein the catalyst component comprises:
palladium; and
at least one metal catalyst selected from the group consisting of nickel, gold, iron, and silver, and combinations thereof.

2. The electrode catalyst of claim 1, wherein the tungsten carbide and carbon composite support has a structure in which tungsten carbide crystalline particles form an island phase and carbon forms a sea phase around the tungsten carbide crystalline particles.

3. The electrode catalyst of claim 1, wherein the tungsten carbide and carbon composite support comprises mesoporous particles having an average particle size from about 0.01 to about 100 μm.

4. The electrode catalyst of claim 1, wherein the tungsten carbide and carbon composite support comprises a plurality of pores having a diameter in a range of about 2 to about 5 nm.

5. The electrode catalyst of claim 1, wherein the tungsten carbide and carbon composite support comprises a pore volume in a range of about 0.08 to about 0.25 cm³/g.

6. The electrode catalyst of claim 1, wherein the amount of the tungsten carbide and carbon composite support is from about 60 to about 95 wt % based on the total amount of the electrode catalyst.

7. The electrode catalyst of claim 1, wherein the amount of the catalyst component is from about 5 to about 40 wt % based on the total amount of the electrode catalyst.

8. The electrode catalyst of claim 1, wherein a weight ratio of palladium to nickel is from about 99.9:0.1 to about 99.999:0.001.

9. The electrode catalyst of claim 1, wherein a weight ratio of palladium to the at least one metal catalyst selected from the group consisting of gold, iron, and silver, and combinations thereof, is from about 40:60 to about 70:30.

10. A membrane electrode assembly (MEA) for a fuel cell, the MEA comprising:
a cathode and an anode disposed to face each other; and
an electrolyte membrane disposed between the cathode and the anode,
wherein the anode comprises:
a tungsten carbide and carbon composite support; and
a catalyst component supported on the tungsten carbide and carbon composite support,
wherein the catalyst component comprises:
palladium; and
at least one metal catalyst selected from the group consisting of nickel, gold, iron, and silver, and combinations thereof.

11. The MEA of claim 10, wherein the tungsten carbide and carbon composite support has a structure in which tungsten carbide crystalline particles form an island phase and carbon forms a sea phase around the tungsten carbide crystalline particles.

12. The MEA of claim 10, wherein the tungsten carbide and carbon composite support comprises mesoporous particles having an average particle size from about 0.01 to about 100 μm.

13. The MEA of claim 10, wherein the tungsten carbide and carbon composite support comprises a plurality of pores having a diameter in a range of about 2 to about 5 nm and a pore volume in a range of about 0.08 to about 0.25 cm³/g.

14. The MEA of claim 10, wherein the amount of the tungsten carbide and carbon composite support is from about 60 to about 95 wt % based on the total amount of the electrode catalyst, and the amount of the catalyst component is from about 5 to about 40 wt % based on the total amount of the electrode catalyst.

15. The MEA of claim 10, wherein, when nickel is the at least one metal catalyst, a weight ratio of palladium to nickel is from about 99.9:0.1 to about 99.999:0.001, and, when the at least one metal catalyst is gold, iron, and/or silver, a weight ratio of palladium to the at least one metal catalyst is from about 40:60 to about 70:30.

16. A fuel cell comprising:
a membrane electrode assembly; and
a separating plate disposed on each side of the membrane electrode assembly,
wherein the membrane electrode assembly comprises:
a cathode and an anode disposed to face each other; and
an electrolyte membrane disposed between the cathode and the anode,
wherein the anode comprises:
a tungsten carbide and carbon composite support; and
a catalyst component supported on the tungsten carbide and carbon composite support,
wherein the catalyst component comprises:
palladium; and
at least one metal catalyst selected from the group consisting of nickel, gold, iron, and silver, and combinations thereof.

17. A method of preparing an electrode catalyst for a fuel cell, the method comprising:
dispersing a tungsten carbide and carbon (WC/C) composite support in a first mixed solvent containing polyol and at least one polar solvent selected from the group consisting of water, C1-C4 aliphatic alcohol, and C1-C4 aliphatic ketone to form a WC/C mesoporous composite support dispersion;
dissolving a metal catalyst precursor in a water single solvent or second mixed solvent containing water and at least one polar solvent selected from the group consisting of C1-C4 aliphatic alcohol, C1-C4 aliphatic ketone, and polyol, to form a metal catalyst precursor solution, the metal catalyst precursor comprising a palladium precursor and at least one metal catalyst precursor selected from the group consisting of a nickel precursor, a gold precursor, an iron precursor, and a silver precursor, and combinations thereof;
mixing the tungsten carbide and carbon (WC/C) mesoporous composite support dispersion and the metal catalyst precursor solution to form a mixture;
refluxing the mixture at a pressure from about 1 to about 5 atm and at a temperature from about 120 to about 180° C. to support the metal catalyst on the WC/C composite support; and
separating and drying the resultant refluxed mixture to obtain the electrode catalyst.

18. The method of claim 17, wherein the used amount of the first mixed solvent is from about 50 to about 200 parts by weight based on 100 parts by weight of the WC/C composite support, and a mixing ratio of the polyol to the at least one polar solvent in the first mixed solvent is about 60 to about 100 parts by weight of the at least one polar solvent based on 100 parts by weight of the polyol.

19. The method of claim 17, wherein the used amount of the metal catalyst precursor is about 3 to about 15 parts by weight based on 100 parts by weight of the water single solvent or the second mixed solvent, and a mixing ratio of the water and the at least one polar solvent in the second mixed solvent is about 10 to about 30 parts by weight of the at least one polar solvent based on 100 parts by weight of the water.

20. The method of claim 17, wherein the used amounts of the palladium precursor and the at least one metal catalyst precursor are adjusted such that a resultant atomic ratio in the electrode catalyst of the palladium to the at least one metal catalyst is from about 3:3 to about 3:1.
